(19) United States
(12) Patent Application Publication
(10) Pub. No.: US 2016/0051434 A1
(43) Pub. Date: Feb. 25, 2016

(54) ARTIFICIAL INTELLIGENCE ASSISTED PHYSICAL THERAPY AND REHABILITATION ROBOT USED FOR TREATMENT OF DAMAGED AND WEAKENED MUSCLES AND REHABILITATION OF THE PATIENT

(71) Applicant: SANKO OZEL EGITIM HIZMETLERI A.S., Gaziantep (TR)

(72) Inventors: Burak ERKILIÇ, Gaziantep (TR); Orhan ÇEVIK, Gaziantep (TR); Furkan ADAL, Gaziantep (TR)

(21) Appl. No.: 14/779,451

(22) PCT Filed: Mar. 27, 2014
(86) PCT No.: PCT/TR2014/000091

§ 371 Date: Sep. 23, 2015

(30) Foreign Application Priority Data
Apr. 5, 2013 (TR) 2013/04119

(51) Int. Cl. A61H 1/02

(52) U.S. Cl. CPC A61H 1/0259; A61H 1/0274; A61H 1/0292; A61H 2201/1607; A61H 2201/1626; A61H 2201/1633; A61H 2201/1638; A61H 2201/1642; A61H 2230/085; A61H 2201/10; A61H 2201/5007; A61H 2201/163

(57) ABSTRACT

A physical therapy and rehabilitation robot with an artificial intelligence for treating congenital or acquired joint, muscle, musculoskeletal system disorders and diseases affecting the locomotor system, minimizing the problems, handicaps or disabilities of the locomotor system, facilitating the daily life and minimizing dependence of a person on others for living, wherein it includes the following: a control panel, a head fastening element, a back fastening element, a leg-hip connection element, an arm exercise mechanism, an arm-shoulder connection mechanism and a leg exercise mechanism.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention is intended to provide a physical therapy and rehabilitation robot, wherein it relates to a physical therapy and rehabilitation robot with an artificial intelligence on its own for treating congenital or acquired joint, muscle, musculoskeletal system disorders and diseases affecting the locomotor system, minimizing the problems, handicaps or disabilities of the locomotor system, facilitating the daily life and minimizing dependence of a person on others for living.

2. Description of Related Art Including Information Disclosed Under 37 CFR 1.97 and 37 CFR 1.98.

Nowadays, congenital or acquired joint, muscle, musculoskeletal system disorders and diseases affecting the locomotor system are one of the most important health problems affecting people. Especially, with the growing population and prolonging human life, said conditions have become one of the important elements reducing the quality of life.

Physical therapy and rehabilitation (PT&R), i.e. physiotherapy, is the treatment performed for the purpose of restoring deficiencies observed in the locomotor system of people due to aforementioned reasons such as congenital disorders, injuries, diseases or aging and comprising healing of patients by means of electrical current, hot or cold application, exercises or various waves. People receiving physical therapy education and practicing said profession are referred to as a physiotherapist.

Today, respective therapy is carried out under the supervision of specialist doctors and physiotherapists in the physical therapy and rehabilitation centers with a variety of instruments and devices. Considering the long process of rehabilitation, high costs are also confronted. In addition, this service can only be provided in certain static centers, implying that it reaches to a certain segment of society. Especially, in rural areas or in areas that are difficult to reach, health care cannot be delivered to the patients unable to go to the hospitals, respective centers due to health problems or climate related problems such as winter conditions.

Considering the need for physical therapy and rehabilitation, insufficiency of number of respective instruments and devices and specialist doctors and physiotherapists stands out. Therefore, respective health service cannot be equally and sufficiently provided to the patients.

For the above reasons, the need for mobile physical therapy and rehabilitation devices not requiring any specialist doctor or physiotherapist supervision becomes more and more apparent. In this context, numerous filed patent applications are available in the literature. One of them is the German patent DE19752912 providing a physical therapy for legs against a resistance force. However, as such this device responds only to the rehabilitation of certain conditions and different tests are required for calculation of said resistance force.

Canadian patent CA2544811 and U.S. Pat. No. 7,628,734 also provide devices by which patients are able to perform various physical therapy exercises. However, they do not comprise support elements for the patient as well as still require specialist doctors or physiotherapists during the use thereof.

Turkish patent 2008/05687 relates to a rehabilitation robot with mobility capable of performing passive and active resistance isotonic and isokinetic exercises as well as physiotherapist movements. However, since said device only allows rehabilitation of lower limb and hip areas it is not deemed appropriate for all patients.

In conclusion, the need for a physical therapy and rehabilitation device with an artificial intelligence on its own minimizing all the problems, handicaps or disabilities of the locomotor system, facilitating the daily life and minimizing dependence of a person on others for living and insufficiency of the existing solutions have made the development in the respective technical field necessary.

### OBJECTS OF THE INVENTION

The present invention is developed by being inspired from the existing situations and seeks to solve the above mentioned drawbacks.

The main object of the physical therapy and rehabilitation robot according to the present invention is to treat congenital or acquired joint, muscle, musculoskeletal system disorders and diseases affecting the locomotor system, to minimize the problems, handicaps or disabilities of the locomotor system, to facilitate the daily life and to minimize dependence of a person on others for living. Said device is expected to treat the following conditions:
Neurological disorders, paralysis
Orthopedic problems
Shoulder and joint disorders
Tension in the shoulder and back muscles
Movement restriction and pain resulting from sports injuries
Postoperative dysfunctions
Low back pain and herniated disc
Neck arthritis
Muscle spasms
Headaches
Position disorders
Elbow, wrist, hand joint and soft tissue disorders
Knee disorders
Rheumatic diseases accompanied by joint swelling and pain, movement restriction
Weakening of the bones (osteoporosis) and settled osteoporosis

Another object of the present invention is to relieve pain in pregnant individuals and prepare the body for delivery by means of exercise and physical training

Another object of the present invention is to provide physical therapy and rehabilitation services by creating a mobile system to the society as a whole, in particular to the patients unable to go to hospitals, the respective centers due to health problems or climate related problems such as winter conditions in rural areas or in areas that are difficult to reach.

Another object of the present invention is to reduce treatment costs by reducing the need for specialist doctors and physiotherapists during physical therapy and to pave the way for accelerating the treatment process. In addition, error rate is also reduced since the treatment will be machine controlled.

### BRIEF SUMMARY OF THE INVENTION

In order to fulfill the aforementioned objects, a physical therapy and rehabilitation robot with an artificial intelligence on its own used in treating congenital or acquired joint, muscle, musculoskeletal system disorders and diseases affecting the locomotor system, minimizing the problems, handicaps or disabilities of the locomotor system and comprising the following is developed: a head fastening element keeping the head and neck area fixed; a back fastening element keeping the back area fixed and providing back exercises; a leg-hip connection element providing hip and thigh exercises; an arm exercise mechanism providing wrist, elbow and shoulder exercises; an arm-shoulder connection element providing shoulder exercises; a leg exercise mechanism providing ankle and knee exercises; and a control panel actuating by means of the motors required element or elements among said head fastening element, said back fastening element, said leg-hip connection element, said arm exercise mechanism, said arm-shoulder connection element and said leg exercise mechanism by issuing on and/or off commands to the motors, providing the respective limbs and/or organs with required exercises, processing the data received from the nerves located in the respective organs and/or limbs by means of electromyography method and determining the limits in the therapy according to sense of pain and/or sudden increases thereof detected from the nerves by means of the sensors.

In a preferred embodiment of the present invention, sensors processing the data obtained by means of electromyography are disposed and thereby the limits in the physical therapy according to the detection of the sense of pain or sudden increases thereof from the nerves located in the area provided with rehabilitation are determined.

In another preferred embodiment of the present invention, physical therapy and rehabilitation of various conditions is provided by using other devices and equipment such as electrotherapy, ultrasound devices, hot back, parallel bands, etc.

### BRIEF DESCRIPTION OF THE DRAWINGS

FIG. 1 is a two dimensional side view of a preferred embodiment of the cabin provided where the physical therapy and rehabilitation robot according to the present invention is positioned.

FIG. 2a is a perspective front view of the physical therapy and rehabilitation robot according to the present invention.

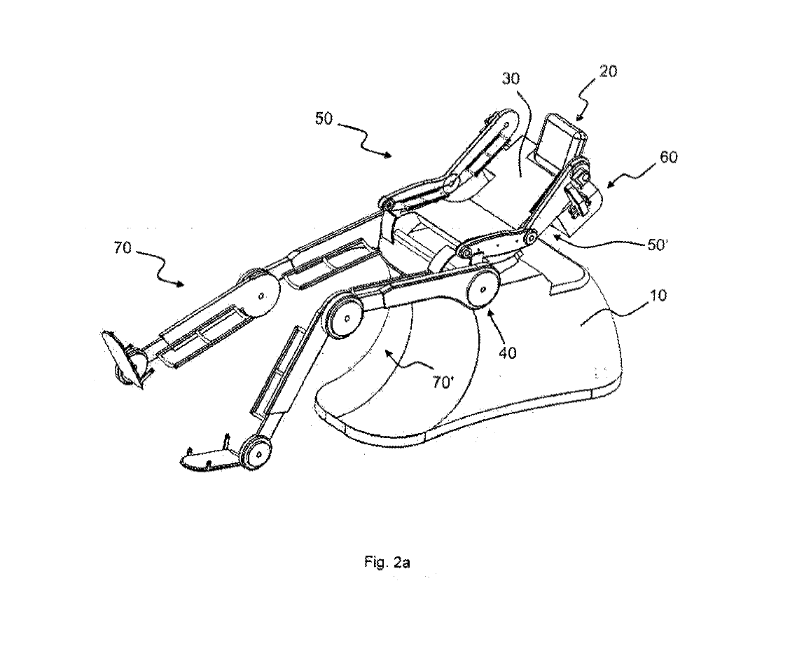

FIG. 2b is a perspective rear view of the physical therapy and rehabilitation robot according to the present invention.

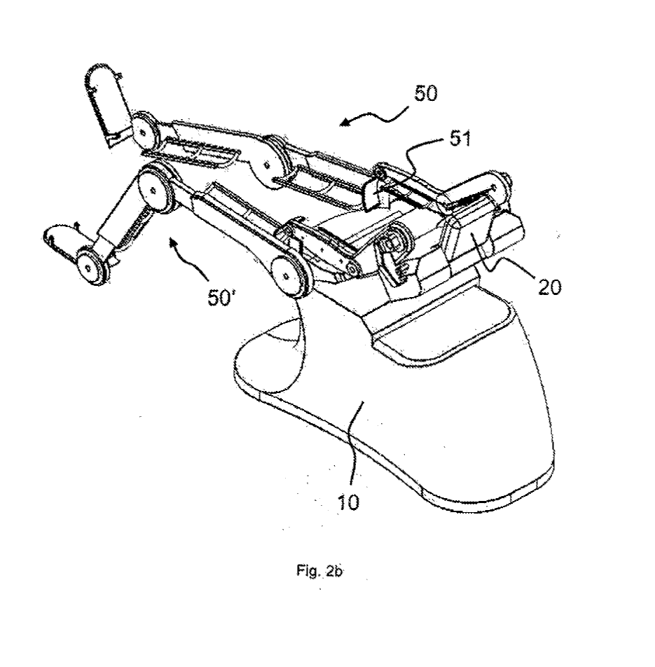

FIG. 2c is a two dimensional top view of the physical therapy and rehabilitation robot according to the present invention.

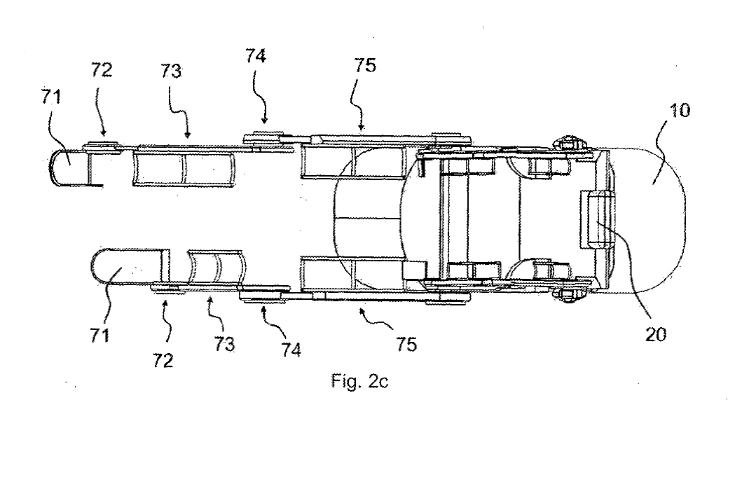

FIG. 2d is a two dimensional side view of the physical therapy and rehabilitation robot according to the present invention.

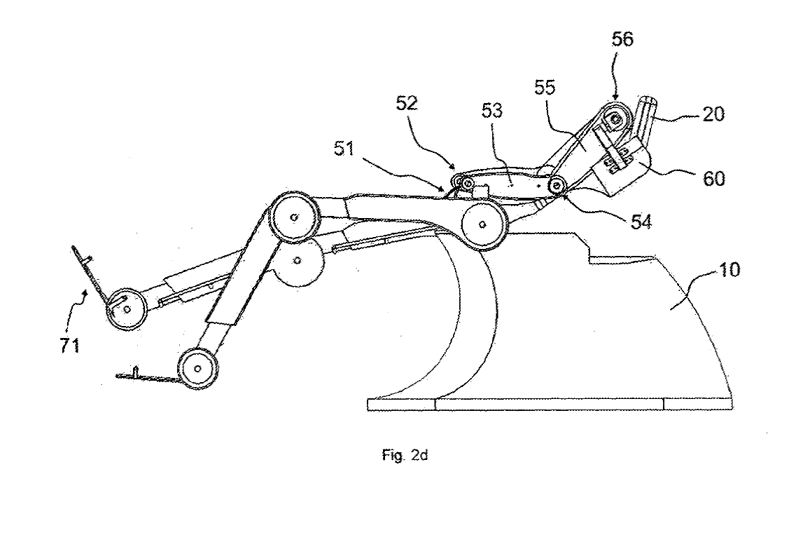

### PART REFERENCES

1 Therapy room
2 Doctor's room
3 Wash room
10 Control panel
20 Head fastening element
30 Back fastening element
40 Leg-hip connection element
50, 50′ Arm exercise mechanism
   51 Hand fastening element
   52 Wrist connection element
   53 Forearm fastening element
   54 Elbow connection element
   55 Humerus fastening element
   56 Shoulder connection element
60 Arm-shoulder connection mechanism
70, 70′ Leg exercise mechanism
   71 Foot fastening element
   72 Ankle connection element
   73 Lower leg fastening element
   74 Knee connection element
   75 Thigh fastening element

### DETAILED DESCRIPTION OF THE INVENTION

In this detailed description, physical therapy and rehabilitation robot according to the present invention is described with examples only for a better understanding of the subject without constituting any restrictive effect.

The preferred embodiment of the physical therapy and rehabilitation robot with an artificial intelligence on its own according to the present invention comprises the following: a head fastening element (20); a back fastening element (30); a leg-hip connection element (40); an arm exercise mechanism (50, 50′); an arm-shoulder connection mechanism (60); a leg exercise mechanism (70, 70′); and a control panel (10) actuating by means of the motors required element or elements among said head fastening element (20), said back fastening element (30), said leg-hip connection element (40), said arm exercise mechanism (50, 50′), said arm-shoulder connection mechanism (60) and said leg exercise mechanism (70, 70′) by issuing on and/or off commands to the motors, providing the respective limbs and/or organs with required exercises, processing the data received from the nerves located in the respective organs and/or limbs by means of electromyography method and determining the limits in the therapy according to sense of pain and/or sudden increases thereof detected from the nerves by means of the sensors.

Motors and electrical circuits of the device are disposed in the control panel (10). PLC software is provided in the circuits disposed in the control panel (10). This software issues on and off commands to the step motors disposed on the device. The motion provided by the step motors provides the necessary exercise movements to the respective limbs and/or organs. The nerves located in the respective organs and/or limbs provided with the exercises are monitored with electromyography method and the received data is transmitted to the control panel (10). Limits of the physical therapy are determined by processing* the data received from the nerves in the control panel (10) according to the resulting sense of pain and/or sudden increases thereof thanks to the integrated software.

Movements of physical therapy and rehabilitation robot are controlled by means of the step motors via control panel (10). Patient's therapy is carried out thanks to the movements of the physical therapy and rehabilitation robot. Patient's condition during the therapy is measured by means of various test devices such as electromyography. The data from the test devices are transmitted to the control panel (10) and step motors are driven according to the information obtained from said data. Thus, automation of the physical therapy and rehabilitation robot is provided.

Head fastening element (20) is the piece designed for fixing the head of the patient. It prevents the pain that may occur in the neck area during the therapy and serves as the support to be placed under the head in the electrotherapy to be applied for the neck hernia.

Back fastening element (30) is the piece designed for supporting patient's back. It is made of aluminum material, covered with a special sheath and anatomically designed such that the surface structure of the piece complies with the anatomical structure of the spine. The back fastening element (30) can be moved 90 degrees and up and down movement thereof is provided by means of the step motors positioned on the leg-hip connection element. In a preferred embodiment of the present invention, infrared lamps are disposed on the back fastening element (30).

The hand fastening element (51) of the arm exercise mechanism (50, 50′) is the piece fixing the patient's hand, thus, wrist (ossa carpi), palm (ossa metacarpi) and finger (ossa phalanges) bones of the patient. It is connected to the piece, forearm fastening element (53), fixing the os ulna and os radialis bones located in the forearm by means of the wrist connection element (52). The step motor disposed in the wrist connection element (52) provides wrist exercises by providing movement to the hand Humerus fastening element (55) is the piece for fixing the humerus bone in the arm and it is connected to the forearm fastening element (53) by means of the elbow connection element (54). The step motor disposed in the elbow connection element (54) provides elbow exercises by providing movement to the elbow. The step motor disposed in the shoulder connection element (56) enables the arm exercise mechanism (50, 50′) to move between 0-180 degrees. In addition, the shoulder connection element (56) transmits the forward and backward movement received from the arm-shoulder connection mechanism (60) to the shoulders. Thus, the way for the therapy of disorders where movements of the shoulder joint, humerus and carpus humerus bones are restricted is paved.

Foot fastening element (71) of the leg exercise mechanism (70, 70′) is the piece for fixing the patient's foot. It is used in the therapy of clinical disorders such as foot drop. It is connected to the piece, lower leg fastening element (73), fixing the calf and shin bones of the lower leg by means of the ankle connection element (72). The step motor disposed in the ankle connection element (72) provides ankle exercises by providing movement to the foot. Thigh fastening element (75) is the piece for fixing the thigh bone in the leg and it is connected to the lower leg fastening element (73) by means of the knee connection element (74). The step motor disposed in the knee connection element (74) provides knee exercises by providing movement to the knee. The step motor disposed in the leg-hip connection element (40) provides thigh exercises by providing movement to the thigh.

In the present invention, robot's mobility, joint and muscle movement mechanisms, motors providing the movement thereof and the software providing the control of the motors are determined by considering the methods used in the rehabilitation and physical therapy of the conditions mentioned below.
Ankylosing Spondylitis (AS): It is a chronic, progressive and painful rheumatic disease affecting particularly the spine, the cause thereof is unknown.
Brachial plexus: Peripheral nerve disorders caused by traffic and occupational accidents and gunshot injuries.
Charcot-Marie-Tooth Syndrome: It is a painless disease leading to difficulty in walking due to the weakened peroneal muscles and progressing to a variety of deformities.
Friedreich's ataxia: It is a progressive autosomal recessive inherited nerve disease that can lead to disorders of speech and walking
eniscopathy: Meniscopathy usually means a meniscus tear and surgery may be required. Meniscopathy can be treated with medication and knee strengthening exercises.
Muscular Dystrophy: It is the common name for muscle diseases.
Osteoarthritis Degenerative Joint Diseases: Aging associated deformations formed by the stress on joints, intra-articular fractures, injuries and inflammations are the factors leading to this disease. Thus, it is also known as the “senile rheumatism”. Hip dislocation is also a cause of arthritis in the progressing stages. Forcing advances the disease while exercise and sports reduce it.
Hemiplegia: Hemiplegia or paralysis refers to the loss of voluntary movement on the right or the left half of the body and paralysis thereof.

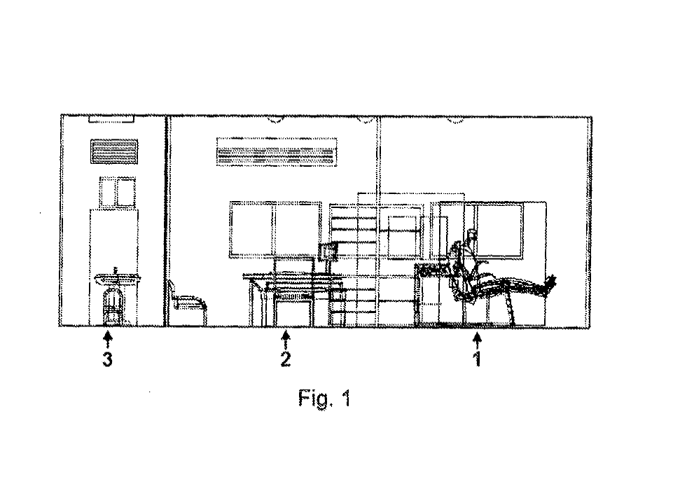

A preferred embodiment of the present invention is disposed inside a cabin design as illustrated in FIG. 1. In said cabin design, basically, following are disposed: a therapy room (1) provided with the physical therapy and rehabilitation robot, a doctor's room (2) for the doctor or physiotherapist and a wash room (3) to be used for purposes such as patient's undressing, preparation and cleaning. Said cabin has an area of 120-200 m², wherein it comprises the devices used in the physical therapy and rehabilitation. Thus, a mobile PT&R center is created, transportation thereof to any kind of physical space and simultaneous utilization of physical therapy and rehabilitation devices is provided.

In a preferred embodiment of the present invention, electromyography device as well as other devices and equipment used in the physical therapy and rehabilitation process such as electrotherapy, ultrasound devices, hot back, parallel bands, etc. are used.

In a preferred embodiment of the present invention, step motors are mounted so as not to restrict the joint movements of the patient.

1. A physical therapy and rehabilitation robot used for treating congenital or acquired joint, muscle, musculoskeletal system disorders and diseases affecting the locomotor system, minimizing the problems, handicaps or disabilities of the locomotor system, characterized in that it comprises the following:
a head fastening element keeping the head and neck area fixed;
a back fastening element keeping the back area fixed and providing back exercises;
a leg-hip connection element providing hip and thigh exercises;
an arm exercise mechanism providing wrist, elbow and shoulder exercises;
an arm-shoulder connection mechanism providing shoulder exercises;
a leg exercise mechanism providing ankle and knee exercises; and
a control panel actuating by means of the motors required element or elements among said head fastening element, said back fastening element, said leg-hip connection element, said arm exercise mechanism, said arm-shoulder connection mechanism and said leg exercise mechanism by issuing on and/or off commands to the motors, providing the respective limbs and/or organs with required exercises, processing the data received from the nerves located in the respective organs and/or limbs by means of electromyography method and determining the limits in the therapy according to sense of pain and/or sudden increases thereof detected from the nerves by means of the sensors.

2. The physical therapy and rehabilitation robot according to claim 1, characterized in that said back fastening element comprises a surface structure complying with the anatomical structure of the spine and the ability to move 90 degrees.

3. The physical therapy and rehabilitation robot according to claim 1, characterized in that said back fastening element comprises infrared lamps.

4. The physical therapy and rehabilitation robot according to claim 1, characterized in that said arm exercise mechanism comprises the following:
a hand fastening element fixing the hand;
a forearm fastening element fixing the os ulna and os radialis bones located in the forearm;
a wrist connection element enabling the wrist exercises to be performed, connecting the hand fastening element and forearm fastening element to each other and providing movement to the hand by means of the step motor disposed thereon;
a humerus fastening element fixing the humerus;
an elbow connection element enabling the elbow exercises to be performed, connecting the forearm fastening element and humerus fastening element to each other and providing movement to the elbow by means of the step motor disposed thereon; and
a shoulder connection element enabling the shoulder exercises to be performed and providing movement to the shoulder by means of the step motor disposed thereon.

5. The physical therapy and rehabilitation robot according to claim 4, characterized in that said shoulder connection element comprises the ability of enabling the arm exercise mechanism to move between 0-180 degrees.

6. The physical therapy and rehabilitation robot according to claim 1, characterized in that said leg exercise mechanism comprises the following:
a foot fastening element fixing the foot;
a lower leg fastening element fixing the calf and shin bones of the lower leg;
an ankle connection element enabling the ankle exercises to be performed, connecting the foot fastening element and lower leg fastening element to each other and providing movement to the foot by means of the step motor disposed thereon;
a thigh fastening element fixing the thigh; and
a knee connection element enabling the knee exercises to be performed, connecting the lower leg fastening element and thigh fastening element to each other and providing movement to the knee by means of the step motor disposed thereon.
